(19) United States
(12) Patent Application Publication
(10) Pub. No.: US 2009/0163160 A1
(43) Pub. Date: Jun. 25, 2009

(54) ADAPTIVE RESPONSIVITY RF RECEIVER DETECTOR SYSTEM

(75) Inventors: John E. Holmes, Scottsdale, AZ (US); Derrick Lim, Queen Creek, AZ (US); Stephen K. Rockwell, Mesa, AZ (US)

Correspondence Address: INGRASSIA FISHER & LORENZ, P.C. (MOT), 7010 E. Cochise Road, SCOTTSDALE, AZ, 85253, US

(73) Assignee: Motorola, Inc., Schaumburg, IL (US)

(21) Appl. No.: 11/962,875

(22) Filed: Dec. 21, 2007

(51) Int. Cl. H04B 17/02

(52) U.S. Cl. 455/134

(57) ABSTRACT

A variable responsivity adaptive detector system (10) for a receiver protects a baseband amplifier from being overdriven and used to detect weak signals at the antenna (14). The RF detector system (10) includes an envelope detector (28) configured to receive an RF signal, and a power detector (20) sensing a magnitude of the received RF signal and providing a DC signal for biasing the envelope detector (28) to modify the magnitude of the received RF signal.

### FIELD

The present invention generally relates to RF receivers and more particularly to a variable responsivity adaptive detector system within a receiver.

### BACKGROUND

The market for personal wireless electronic devices, for example, cell phones, personal digital assistants (PDA's), digital cameras, and music playback devices (MP3), is very competitive. Manufacturers are constantly improving their product with each model in an attempt to cut costs and production requirements.

Global telecommunication systems, such as cell phones and two way radios, are migrating to higher frequencies and data rates due to increased consumer demand on usage and the desire for more content. Current mobile devices are challenged by the increased functionality and complexity of multi-modes, multi-bands, and multi-standards, and progressing beyond 3G with the increasing requirement of multimedia, mobile internet, connected home solutions, sensor-network, high-speed data connectivity such as Bluetooth, RFID, WLAN, WiMAX, UWB, and 4G. Limited battery power and tight design space will become bottlenecks for the high integration and development of mobile devices. The tight design space is especially challenging for RF technologies and the requisite design/fabrication of adaptive/tunable antennas and antenna arrays.

Signals received at an antenna may encompass a wide range of power. Signals having a high magnitude of power may overdrive a baseband amplifier and signals having a low magnitude may be difficult to detect. Conventional automatic responsivity control circuits are known to decrease the magnitude of a high power received signal and to increase the magnitude of a low power received signal. These circuits typically include a variable gain amplifier coupled to the output and a differential amplifier for comparing the output with a reference source to produce a voltage controlling the gain of the variable gain amplifier. However, these conventional circuits require additional circuitry.

U.S. Pat. No. 3,784,848 uses a varying amplitude of an oscillating signal generated from a touch receptor to change the detector sensitivity in a touch control circuit.

U.S. Pat. No. 3,795,811 accomplishes automatic responsivity control by means of a reference signal derived from a modulated light source. The source illuminates both the infrared element array and a separate reference signal detector. The infrared video signal and the reference signal transmitted in each channel are passed through a variable gain amplifier. The magnitude (gain) of the reference signal is controlled by a circuit including a synchronous filter, a synchronous detector, a DC reference voltage circuit, and a voltage controlled resistor. A separate reference signal detector provides a drive signal to control the synchronous filter and also provide a 180 degree phase shifted reference signal that is used to cancel the reference signal in the output of the VGA.

U.S. Pat. No. 4,276,474 provides automatic responsivity control for an array of infrared photodetectors. A modulated reference signal is provided by uniformly modulating the bias voltage applied to each of the plurality of photodetectors in the array. Photodetectors having different responsivities respond to the same bias modulation differently to produce a superimposed sinusoidal component in the photodectector output current which is used to compensate for differences in responsivities of the individual photodetectors. An autoresponsivity control circuit selects the superimposed sinusoidal component from the photodetector output current corresponding to the frequency of the reference signal modulating the bias voltage, and compares the amplitude of the selected sinusoidal component with a reference level to adjust the amplification at the photodetector output in accordance with this comparison, so that the amplified outputs from the plurality of photodetectors respond uniformly to the sinusoidal reference signal applied as a bias voltage to the photodetectors.

Accordingly, it is desirable to provide a variable responsivity adaptive detector system for a receiver that can reduce dynamic range requirements for a baseband amplifier and can be implemented adaptively to self adjust for varying incident signal levels and frequencies. Furthermore, other desirable features and characteristics of the present invention will become apparent from the subsequent detailed description and the appended claims, taken in conjunction with the accompanying drawings and this background.

### BRIEF DESCRIPTION OF THE DRAWINGS

Embodiments of the present invention will hereinafter be described in conjunction with the following drawing figures, wherein like numerals denote like elements, and

FIG. 1 is a block diagram of a variable responsivity adaptive detector system in accordance with a first embodiment;

FIG. 2 is a graph of responsivity versus bias for the first embodiment;

FIG. 3 is a diagram of an exemplary RF detector voltage and desired RF envelope detector control voltage versus RF signal power.

FIG. 4 is a diagram of a ASK modulated low power RF input signal;

FIG. 5 is a diagram of a ASK modulated high power RF input signal;

FIG. 6 is a diagram of an amplitude modulated wave form demodulated to a constant amplitude baseband differing RF signal amplitude using adaptive responsivity in accordance with the exemplary embodiments.

FIG. 7 is a block diagram of a variable responsivity adaptive detector system in accordance with a second embodiment; and

FIG. 8 is a graph of the gain versus frequency for different control voltage levels used to vary the gain in accordance with the second embodiment.

### DETAILED DESCRIPTION

The following detailed description is merely exemplary in nature and is not intended to limit the invention or the application and uses of the invention. Furthermore, there is no intention to be bound by any theory presented in the preceding background or the following detailed description.

An applied DC bias voltage adaptively controls the responsivity/sensitivity of an envelope detector within an RF receiver used to receive and demodulate amplitude modulated signals. Responsivity and sensitivity are used interchangeably to mean the ratio of wattage to voltage, or the input-output gain of a detector system. Received power at an antenna is coupled to a power detector which converts RF power into a DC voltage proportional to the received power at the antenna. Through a combination of detector diode selection, orientation, and buffer or differential amplification, this DC voltage can be applied to the envelope detector to vary the responsivity/sensitivity adaptively in relation to the received power at the antenna. Therefore, as power increases at the antenna, the responsivity of the detector decreases, or as power decreases at the antenna, the responsivity of the detector increases. The use of a DC bias voltage to control the responsivity of the envelop detector allows for improved dynamic range over conventional RF detector systems. This approach can also be implemented with systems using AGC (automatic gain control) to allow for even greater dynamic range.

Referring to FIG. 1, a first embodiment includes the adaptive responsivity detector system 10 having an input conductor 12 configured, for example to be coupled to an antenna 14, for providing a received signal to a coupler 16. The received signal having a carrier frequency, for example in the range up to 3.0 THz, but preferably of approximately 60 GHz, is forwarded from the input conductor 12 to a low noise amplifier 18 in a conventional fashion. In accordance with the preferred exemplary embodiment, the received RF signal is envelope detected using RF envelope detector 28. The RF envelope detector 28 comprises the bias tee circuit 26 coupled between a diode 36 and the low noise amplifier 18. A load at the output of the envelope detector 28 is represented by a resistor 37. This bias tee circuit 26 serves to isolate a DC input bias to the envelope detector diode 34 from the RF carrier frequency. A bias applied to RF envelope detector 28 may be used to control the responsivity of the detector.

Coupler 16 may be implemented in any known fashion known, but preferably in a manner consistent with integration on a common substrate. This coupling factor, or relative signal sampled by the coupling, is preferably at least 10 dB reduced from the original signal to minimize impact on receiver sensitivity. The power detector 20, comprising a diode 22 and load resistor 23 transforms power (RF signal from the coupler 16) into a DC voltage proportional to the received power at the antenna. This DC voltage can be converted by a differential amplifier 24 into a control signal that is applied to the detector 28 to vary the responsivity/sensitivity adaptively in relation to the received power at the antenna 14. Therefore, as power increases at the antenna 14, the responsivity of the envelope detector 28 decreases, or as power decreases at the antenna 14, the responsivity of the envelope detector 28 increases. The use of a DC bias voltage to control the responsivity of the envelope detector 28 allows for improved dynamic range over conventional RF detector systems.

Using a highly nonlinear diode as the diode 36, for example, a Schottky diode or the Junction Engineered Dual Insulator (JEDI) technology developed at the University of Colorado as described in U.S. Pat. No. 6,563,185, allows for very high frequency detection. Through the use of this low cost, half-duplex JEDI technology, the integrated RF variable responsivity detector may be fabricated on non-semiconductor substrates such as FR-4 boards or any material including, for example, quartz, ceramics, Teflon, polyimides, plastic, liquid crystal polymer, and epoxy. Improved performance is accomplished by eliminating or reducing lossy interconnects, and positioning the demodulator in the vicinity of the antenna.

The JEDI technology comprises nanoscale stacks of metals and insulators for creating ultra-high frequency diodes, antennas, and transistors operating at frequencies from DC to 3.0 THz. More specifically, a second layer of insulator and metal may be substituted for the semiconductor found in metal-oxide semiconductors, resulting in a four-layer stack of metal-insulator-insulator-metal (MIIM). A quantum well is formed between the insulators that allow only high-energy tunneling. Consequently, when a voltage is applied to the top metal that exceeds its threshold, a ballistic transport mechanism accelerates tunneling electrons across the insulator gap. In accordance with the exemplary embodiment, the diode 36 is chosen to have a nonlinear I/V characteristic which is resistive in nature. In other words, as an applied RF signal swings across the I/V characteristic of the diode, the effective resistance is changing in a time varying manner.

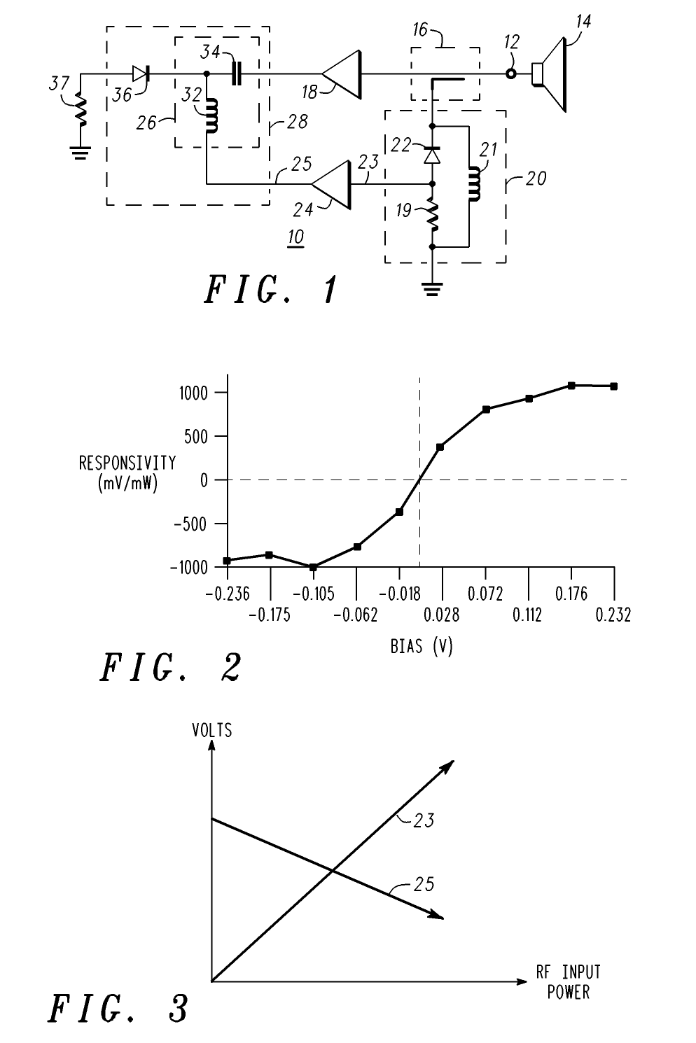

FIG. 2 is a graph of responsivity versus bias voltage for a JEDI diode. As the amplitude of bias voltage increases, the responsivity (power/voltage) increases. In general, controlling the voltage of a detector diode can alter its responsivity characteristics, providing the opportunity to implement an adaptive responsivity RF receiver.

The RF power detector 20 combined with amplifier 24 can be designed or configured by those skilled in the art to produce the appropriate control voltage necessary to control the RF envelope detector 28 in the desired manner. In this embodiment, the RF power detector may generate a positive DC voltage 23 which increases for higher RF signal strength to the antenna 14. By loading the power detector 20 with a large DC load 19, the responsivity of the power detector 20 can be optimized to detect the average carrier power. The inductor 21 coupled to ground is needed to provide a DC current return path for the rectified DC voltage 23 generated across the diode 22. The inductor 21 prevents shorting out the RF signal. A high input impedance differential amplifier 24 can be used to level shift and invert the slope of the DC control signal 25 to the RF envelope detector 28. Many other possible designs or configurations may be used to implement a similar function. Preferably, in this embodiment, a JEDI device, scaled for best average power detection would be used to allow higher levels of integration.

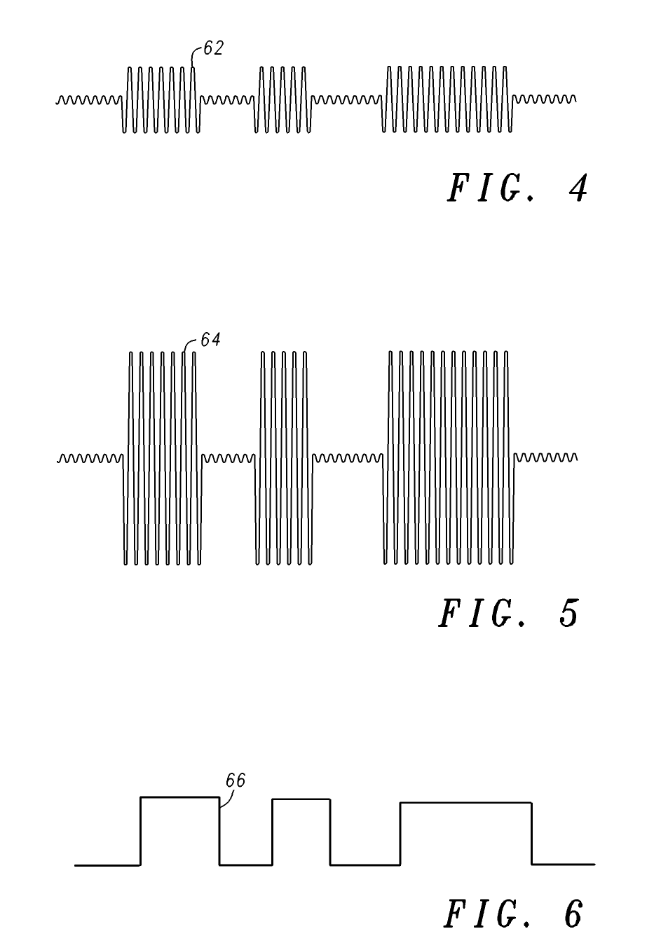

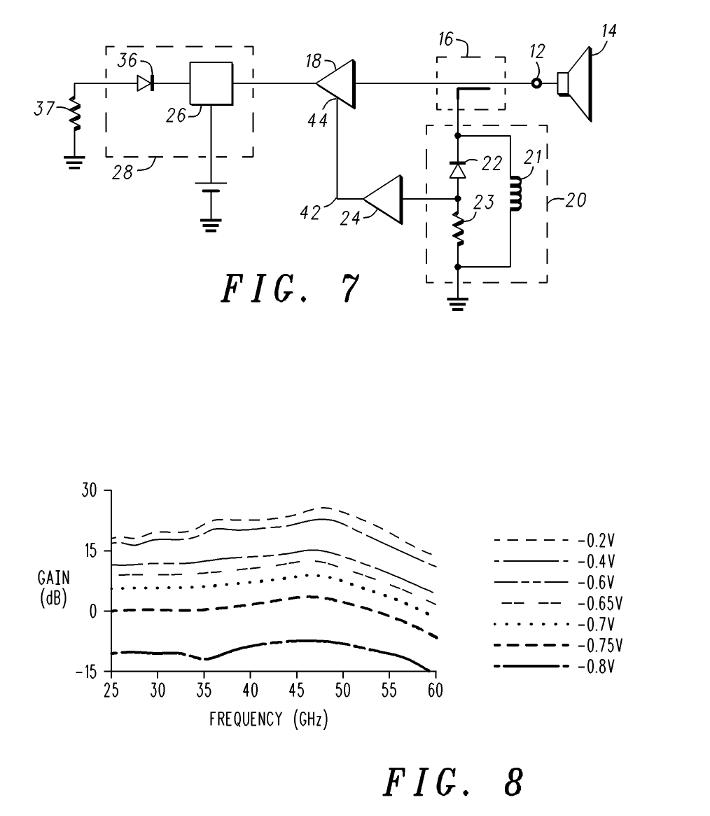

FIGS. 4-6 show how an amplitude modulated signal is envelope detected in this adaptive responsivity receiver exemplary embodiment. By adapting the receiver responsivity or gain, the digital baseband signal can be constrained to smaller range of amplitudes for a given range of RF input signals, thereby reducing the baseband architecture dynamic range requirements. FIG. 4 is a received RF signal 62 having a low power and FIG. 5 is a received RF signal 64 having a high power. The exemplary embodiment will provide a signal 66 shown in FIG. 6 in response to either of the RF signal 62 having a low power (FIG. 4) or the RF signal 64 having a high power (FIG. 5).

Referring to FIG. 7, a second exemplary embodiment includes coupling the node 42 between the inverting amplifier 24 and the anode of the power detector diode 22 to a control gate 44 of the low noise amplifier 18, thereby controlling the gain of a variable gain amplifier 18 in a similar fashion as the variable responsivity detector is controlled in the first embodiment.

FIG. 8 is a graph showing the gain versus frequency for a typical RF amplifier. In this embodiment amplifier 18 may be gained controlled using a similar RF power detector approach used to control the responsivity of the RF envelope detector of FIG. 1. By modifying the differential amplifier 28 circuit the appropriate DC control voltage versus incident RF input power may be achieved.

Both of these embodiments could be combined to achieve better overall dynamic range in the receiver. A combining of these two exemplary embodiments would provide a differentiated signal to both the gate 44 of the low noise amplifier 18 and the bias tee circuit 26. Separate control signal circuits may be required for each.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims.

1. An RF detector system comprising:
an envelope detector configured to receive an RF signal; and
a power detector sensing a magnitude of the received RF signal and providing a DC signal for biasing the envelope detector to modify the magnitude of the received RF signal.

2. The RF detector system of claim 1 wherein the power detector includes:
an input conductor receiving the RF signal;
a coupler coupled to the input conductor; and
a first diode coupled to the coupler.

3. The RF detector system of claim 2 further comprising a differential amplifier coupled between the first diode and the envelope detector.

4. The RF detector system of claim 3 wherein the envelope detector comprises:
bias circuitry coupled to the input conductor and the differential amplifier; and
a second diode coupled to the bias circuitry for providing an output.

5. The RF detector system of claim 4 wherein the second diode comprises a nonlinear diode.

6. The RF detector system of claim 1 wherein the envelope detector receives an RF signal in a range up to 3.0 THz.

7. The RF detector system of claim 1 wherein the envelope detector receives an RF signal of approximately 60 Hz.

8. The RF detector system of claim 1 wherein the envelope detector and the power detector are formed on a substrate comprising a non-semiconducting material.

9. An RF detector system comprising:
an input conductor configured to receive an RF signal having a first magnitude;
a low noise amplifier coupled to the input conductor;
a coupler coupled to the input conductor for sensing the magnitude of the first RF signal;
a power detector coupled to the coupler for converting the first RF signal to a DC signal;
a differential amplifier coupled to the power detector for adjusting the DC signal voltage;
an output conductor; and
an envelope detector coupled to the low noise amplifier for providing the RF signal having a second magnitude to the output conductor, the envelope detector comprising:
a bias tee responsive to the inverted DC signal for adjusting the magnitude of the RF signal from the first magnitude to the second magnitude; and
a envelope detector diode coupled between the bias tee and the output conductor for providing the RF signal having the second magnitude to the output conductor.

10. The RF detector system of claim 9 wherein the envelope detector diode comprises a nonlinear diode.

11. The RF detector system of claim 9 wherein the envelope detector receives an RF signal in a range up to 3.0 THz.

12. The RF detector system of claim 9 wherein the envelope detector receives an RF signal of approximately 60 Hz.

13. The RF detector system of claim 9 wherein the envelope detector and the power detector are formed on a substrate comprising a non-semiconducting material.

14. A method of adjusting the magnitude of a received RF signal within an RF receiver, comprising:
converting a signal representative of the RF signal to a DC signal; and
modifying the magnitude of the received RF signal in response to the DC signal.

15. The method of claim 14 wherein the converting step includes sampling the received RF signal and providing a relative signal at least 10 dB reduced from the received RF signal.

16. The method of claim 14 wherein the modifying step comprises modifying the received RF signal having a frequency in a range extending to 3.0 THz.

17. The method of claim 14 wherein the modifying step comprises modifying the received RF signal having a frequency of approximately 60 GHz.

18. The method of claim 14 further comprising providing the modified received RF signal as an output through a nonlinear diode.

19. The method of claim 14 wherein the modifying step is accomplished by an envelope detector and the DC signal adaptively controls the responsivity of the envelope detector.

20. The method of claim 14 wherein the modifying step is accomplished by an envelope detector and the DC signal increases dynamic range of the RF receiver.
